(19) United States
(12) Patent Application Publication
(10) Pub. No.: US 2007/0057487 A1
(43) Pub. Date: Mar. 15, 2007

(54) Air bag module

(75) Inventor: Gun Woo Kim, Sungnam-si (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Yongin-shi (KR)

(21) Appl. No.: 11/305,090

(22) Filed: Dec. 19, 2005

(30) Foreign Application Priority Data
Sep. 12, 2005 (KR) 2005-84847

(51) Int. Cl. B60R 21/21; B60R 21/23

(52) U.S. Cl. 280/728.2; 280/732; 280/743.2

(57) ABSTRACT

An air bag module has an outer tether provided on the outer side of a cushion with a sewing portion and a tear line for suppressing an initial forward deployment of the cushion, and thus it is able to simply adjust the forward deployment speed and deployment rate of the cushion by tuning the sewing portion, sewing force and tear line of the outer tether.

This Nonprovisional application claims priority under 35 U.S.C. § 119(a) on Patent Application No. 10-2005-84847 filed in Korea on Sep. 12, 2005, the entire contents of which are hereby incorporated by reference.

### BACKGROUND OF THE INVENTION

1. Field of the Invention

The present invention relates to an air bag module which is disposed on the outer side of a cushion and has an outer tether provided with a sewing portion and a tear line that are tearable by the expansion pressure of the cushion for suppressing an initial forward deployment of the cushion.

2. Description of the Background Art

Generally, an air bag for vehicles may be classified into a driver air bag (DAB) which is mounted to a handle for protecting the driver in a driver's seat and a passenger air bag (PAB) which is mounted to an instrument panel in front of a passenger's seat for protecting the passenger in a passenger's seat. Basically, the driver air bag is requisite, and the passenger air bag is optional; however, vehicles with passenger air bags basically mounted therein for protecting passengers from injury are on the increase in recent years.

FIG. 1 is a cross sectional view of an air bag module according to the conventional art. FIG. 2 is a perspective view showing a cushion assembly of the air bag module according to the conventional art.

The air bag module as shown in FIGS. 1 and 2 comprises: an air bag housing 2 fixed to a vehicle; a cushion assembly 10 accommodated in the front part of the air bag housing 2; and an inflator 20 mounted to the rear part of the air bag housing 2 for supplying expansion gas when a collision occurs.

The cushion assembly 10 includes a cushion 12 accommodated in the air bag housing 2 while being folded in a prescribed shape and expanded toward a passenger by the expansion pressure of the inflator 20 and a retainer 14 for coupling the cushion 12 to the air bag housing 2.

The cushion assembly 10 further includes an OPF 16 disposed on the outer side of the cushion 12 for suppressing an initial forward deployment of the cushion 12 by a frictional force, so that one region of the cushion 12 is not aggressively deployed toward a passenger, that is, so as to prevent an out-of-force phenomenon, even if the expansion pressure of the inflator 20 is eccentrically supplied.

The OPF 16 is folded while being overlapped many times in a predetermined shape or being rolled up so as to have a frictional force at the time of expansion of the cushion 12.

Especially, the OPF 16 is coated so as to have a sufficient frictional force.

The operation of the present invention thus constructed will now be described.

When a collision having a severity greater than a predetermined severity occurs, a high-pressure expansion gas is emitted from the inflator 20. The high-pressure expansion gas is filled in the cushion 12.

At this time, the forward deployment of the cushion 12 is suppressed by the frictional force of the OPF 16 in the initial stage of the deployment of the cushion 12. When the expansion pressure of the cushion 12 increases to a certain point, the OPF 16 is released and the cushion 12 is deployed forward while inflating like a balloon.

Then, the passenger seated in front of the cushion 12 is safely protected by the buffering action of the cushion 12.

In the air bag module according to the conventional art, however, the OPF 16 is coated so as to have a sufficient frictional force, and the OPF 16 is folded by a manual work. Consequently, the manufacturing time is relatively long, and the cost is increased.

In addition, the conventional art is disadvantageous from the viewpoint of uniform quality because deviations in the initial forward deployment suppression performance of the cushion 12 are large according to the folding quality of the OPF 16. Moreover, if the frictional force of the OPF 16 is too large, the OPF 16 may be ruptured or scattered and the expansion of the cushion 12 is delayed, thereby deteriorating the reliability.

### SUMMARY OF THE INVENTION

Therefore, the present invention has been made in view of the above problems, and it is an object of the present invention to provide an air bag module which can reduce the manufacturing time and manufacturing cost and provide a uniform initial forward deployment suppression performance of a cushion by having an outer tether provided with a tear line and at least one sewing portion for suppressing the initial forward deployment of the cushion.

To accomplish the above object, there is provided an air bag module according to the present invention, comprising: an air bag housing; an inflator mounted to the air bag housing; a cushion accommodated in the air bag housing such that the cushion is expanded by the inflator; and an outer tether disposed on the outer side of the cushion and provided with a tear line formed at one side and a sewing portion sewn while being folded so as to be tearable by the expansion pressure of the cushion.

The ends of the outer tether are fixed to the air bag housing along with the cushion.

The tear line is formed in the central region of the outer tether.

The tear line is formed in the width direction of the outer tether.

The sewing portion is provided in a plural number.

A seam of the sewing portion is formed in the width direction of the outer tether.

A seam of the sewing portion is formed in the length direction of the outer tether.

The seam of the sewing portion is provided in a plural number in a width direction.

A seam of the sewing portion is formed at the left and right sides of the tear line.

The sewing portion is sewn to be overlapped once.

The thus-constructed air bag module according to the present invention has an outer tether provided on the outer side of a cushion with a sewing portion and a tear line for suppressing an initial forward deployment of the cushion, and thus it is able to simply adjust the forward deployment speed and deployment rate of the cushion by tuning the sewing portion, sewing force and tear line of the outer tether.

Furthermore, the outer tether is provided on the outer side of the cushion, which makes the structure of the air bag module simpler and the manufacture thereof easier than when an inner tether is provided on the inner side of the cushion.

Furthermore, once the outer tether is fixed to the air bag housing along with the cushion after it is cut out, the assembling of the outer tether is completed, which reduces the manufacturing time and manufacturing cost.

Furthermore, the formation of the seam and tear line of the sewing portion of the outer tether can be done by an automatic process, which makes the initial forward deployment suppression performance of the cushion uniform and improved.

### BRIEF DESCRIPTION OF THE DRAWINGS

The above objects, features and advantages of the present invention will become more apparent from the following detailed description when taken in conjunction with the accompanying drawings, in which:

FIG. 1 a cross sectional view of an air bag module according to the conventional art;

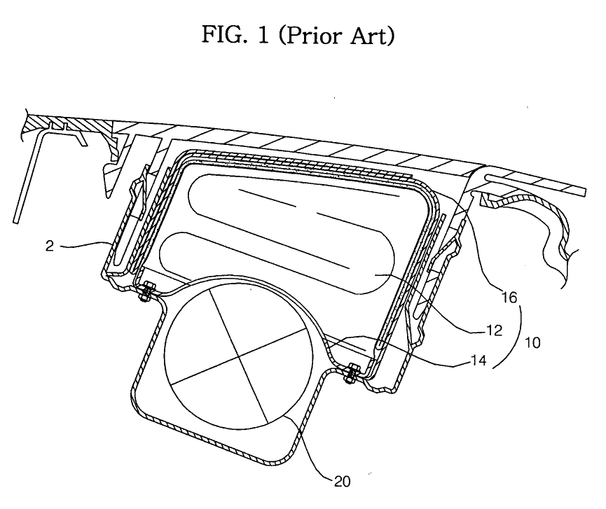

FIG. 2 is a perspective view showing a cushion assembly of the air bag module according to the conventional art;

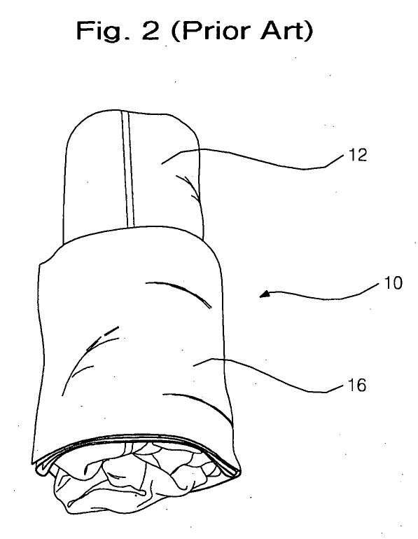

FIG. 3 is a cross sectional view of an air bag module before deployment according to a first embodiment of the present invention;

FIG. 4 is a cross sectional view of the air bag module during deployment according to the first embodiment of the present invention;

FIG. 5 is a cross sectional view of the air bag module after deployment according to the first embodiment of the present invention;

FIG. 6 is an expansive view of an outer tether of the air bag module according to the first embodiment of the present invention;

FIG. 7 is a cross sectional view of an air bag module before deployment according to a second embodiment of the present invention; and

FIG. 8 is an expansive view of an outer tether of the air bag module according to the second embodiment of the present invention.

### DETAILED DESCRIPTION OF THE PREFERRED EMBODIMENTS

Hereinafter, embodiments of an air bag module according to the present invention will now be described with reference to the accompanying drawings.

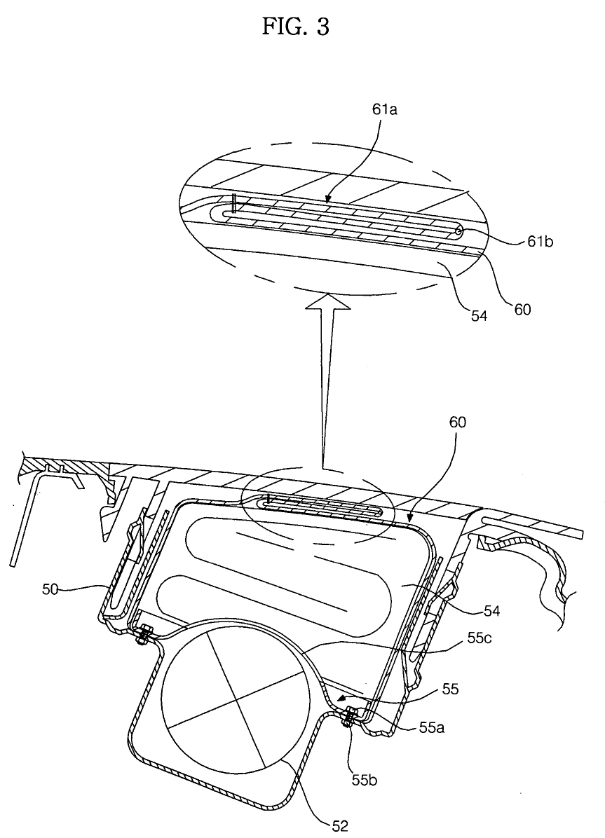

Hereinafter, embodiments of the present invention will be described in detail with reference to FIGS. 3 to 6.

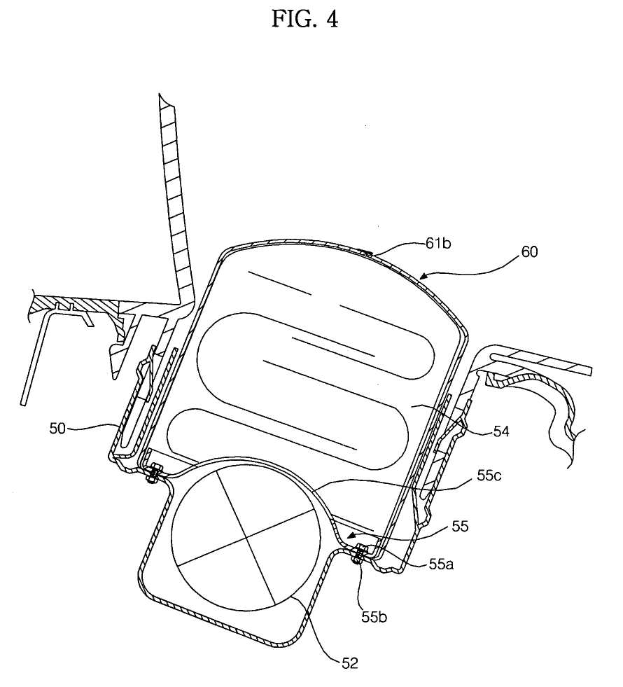

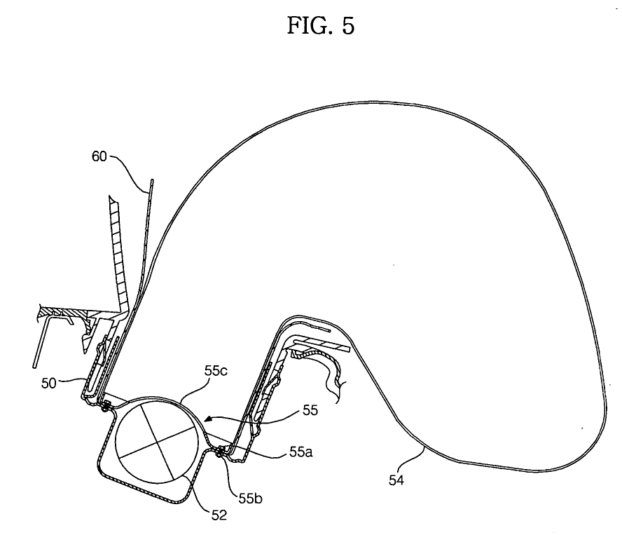

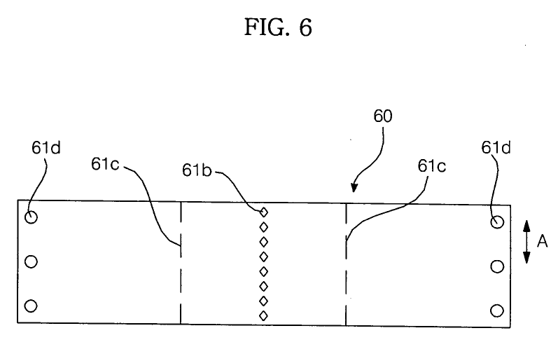

FIG. 3 is a cross sectional view of an air bag module before deployment according to a first embodiment of the present invention. FIG. 4 is a cross sectional view of the air bag module during deployment according to the first embodiment of the present invention. FIG. 5 is a cross sectional view of the air bag module after deployment according to the first embodiment of the present invention. FIG. 6 is an expansive view of an outer tether of the air bag module according to the first embodiment of the present invention.

The air bag module according to the first embodiment of the present invention comprises: an air bag housing 50 fixed to a vehicle; an inflator 52 mounted to the rear part of the air bag housing 50; a cushion 54 accommodated in the air bag housing 50 while being folded in a prescribed shape such that the cushion is expanded by the inflator 52; and an outer tether 60 disposed on the outer side of the cushion 54 for suppressing an initial forward deployment of the cushion 54.

An inlet end of the cushion 54 opened so as to introduce the expansion pressure of the inflator 52 thereinto is fixed in the middle of the air bag housing 50 through a retainer 55.

The retainer 55 is provided integral with a stud 55a for fixing the opened inlet end of the cushion 54 to the air bag housing 50. Of course, a nut 55b is fastened to the end of the stud 55a so that the cushion 54 and the retainer 55 do not fall off from the air bag housing 50.

On the retainer 55, at least one retainer hole 55c is formed for passing the expansion pressure of the inflator 52 through.

The expansion pressure of the inflator 52 is controlled in multiple stages according to the type of a passenger in accordance with a physical condition of the passenger, a sitting position of the passenger, etc.

At this time, the above passenger type information can be acquired through a passenger sensor provided in the seat occupied by a passenger for sensing the load of the passenger, the pressure distribution of the passenger on the seat and so on.

The outer tether 60 is a fabric having a sufficient length to cover the cushion 54 folded in the prescribed shape.

The outer tether 60 has a sewing portion 61a which is formed by overlapping a remaining portion after covering the cushion 54 folded in the prescribed shape in front of the cushion 54 folded in the prescribed shape, and is sewn to an extent to be torn by the expansion pressure of the cushion 54.

The length of the sewing portion 61a of the outer tether is tuned so as to suppress the initial forward deployment of the cushion to an optimum state.

Although the sewing portion 61a of the outer tether 60 may be sewn to be overlapped twice or more, it is preferably sewn to be overlapped once for reducing the material cost.

The sewing portion 61a of the outer tether 60 may be provided in a singular number, and naturally it may be provided in a plural number at left and right sides or upper and lower sides.

A tear line 61b is formed in the central region of the outer tether 60 so that it can be cut out by the expansion pressure of the cushion 54.

The tear line 61b of the outer tether 60 is tuned in its shape, length, size and so on so as to suppress the initial forward deployment of the cushion 54 to an optimum state.

A seam 61c of the sewing portion 61a of the outer tether 60 may be formed in the width direction (arrow A) of the outer tether 60. At this time, the length of the seam 61c of the sewing portion 61a of the outer tether 60 is the same as or less than the width of the sewing portion 61a of the outer tether 60.

The seam 61c of the sewing portion 61a of the outer tether 60 is formed at the left and right sides of the tear line 61b.

The outer tether 60 has stud holes 61d formed respectively at both ends such that it is fixed to the air bag housing 50 by the retainer 55 along with the cushion 54.

The operation of the first embodiment thus constructed according to the present invention will now be described.

When a collision occurs, the expansion pressure of the inflator 52 is supplied to the cushion 54.

At this time, as shown in FIG. 3, the initial forward deployment of the cushion 54 is firstly suppressed by the outer tether 60 in the initial stage.

With the initial forward deployment of the cushion 54 being firstly suppressed, the expansion pressure of the inflator 52 is filled in the cushion 54 to a certain extent. Then, as shown in FIG. 4, as the sewing portion 61a of the outer tether 60 is torn, the cushion 54 is deployed forward to a predetermined extent, and thereafter the initial forward deployment of the cushion 54 is secondly suppressed by the outer tether 60.

After the initial forward deployment of the cushion 54 is secondly suppressed, when more of the expansion pressure of the inflator 52 is filled in the cushion 54, as shown in FIG. 5, the tear line 61b of the outer tether 60 is torn.

When even the tear line 61b of the outer tether 60 is torn, the cushion 54 is fully expanded by the expansion pressure of the inflator 52 without any disturbance.

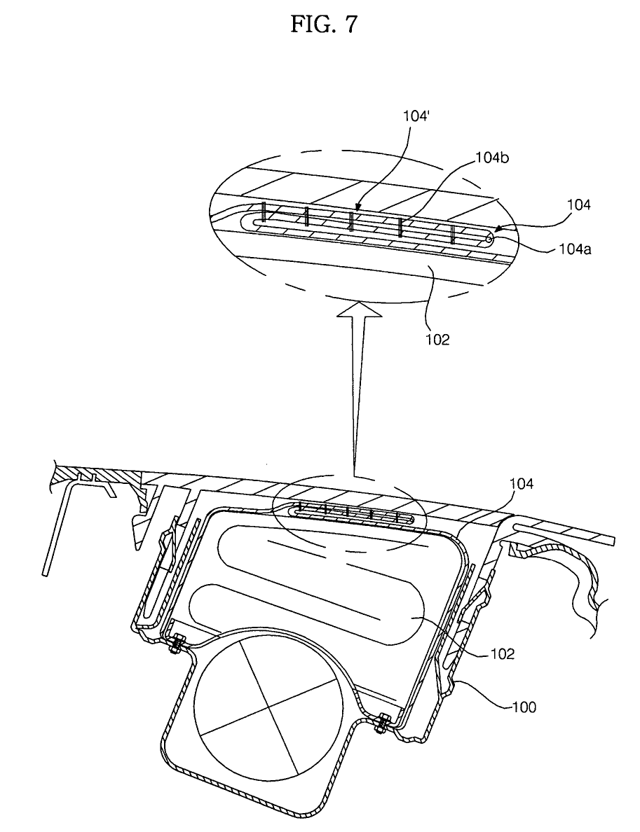

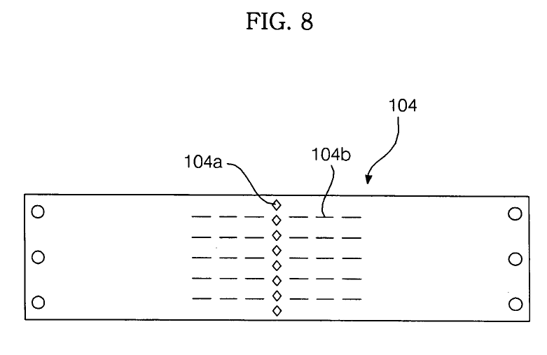

FIG. 7 is a cross sectional view of an air bag module before deployment according to a second embodiment of the present invention. FIG. 8 is an expansive view of an outer tether of the air bag module according to the second embodiment of the present invention.

Hereinafter, the air bag module according to the second embodiment of the present invention will be described in detail. But, a detailed description of the structure same as and similar to that of the first embodiment of the present invention will not be repeated.

The air bag module according to the second embodiment of the present invention comprises an outer tether 104 disposed on the outer side of a cushion 102 accommodated in an air bag housing 100 and having as sewing portion 104′ for suppressing an initial forward deployment of the cushion 102.

A tear line 104a is formed in the central region of the outer tether 104 so as to be cut out by the expansion pressure of the cushion 102.

The sewing portion 104′ of the outer tether 104 is formed in the length direction (arrow B) of a seam 104b, and may be provided in a plurality of lines in the width direction thereof.

In the outer tether 104 according to the second embodiment thus constructed according to the present invention, upon expansion, when an expansion pressure is filled in the cushion 102 to a certain extent, the sewing portion 104′ is torn, and when more of the expansion pressure is filled in the cushion 102, the sewing portion 104′ is torn along the tear line 104a, thereby suppressing the initial deployment of the cushion 102.

The effects of the thus constructed air bag module according to the present invention will now be described.

The air bag module according to the present invention has an outer tether provided on the outer side of a cushion with a sewing portion and a tear line for suppressing an initial forward deployment of the cushion, and thus it is able to simply adjust the forward deployment speed and deployment rate of the cushion by tuning the sewing portion, sewing force and tear line of the outer tether.

Furthermore, the outer tether is provided on the outer side of the cushion, which makes the structure of the air bag module simpler and the manufacture thereof easier than when an inner tether is provided on the inner side of the cushion.

Furthermore, once the outer tether is fixed to the air bag housing along with the cushion after it is cut out, the assembling of the outer tether is completed, which reduces the manufacturing time and manufacturing cost.

Furthermore, the formation of the seam and tear line of the sewing portion of the outer tether can be done by an automatic process, which makes the initial forward deployment suppression performance of the cushion uniform and improved.

What is claimed is:

1. An air bag module, comprising:
an air bag housing; an inflator mounted to the air bag housing;
a cushion accommodated in the air bag housing such that the cushion is expanded by the inflator; and
an outer tether disposed on the outer side of the cushion and provided with a tear line formed at one side and a sewing portion sewn while being folded so as to be tearable by the expansion pressure of the cushion.

2. The air bag module as set forth in claim 1, wherein the ends of the outer tether are fixed to the air bag housing along with the cushion.

3. The air bag module as set forth in claim 1, wherein the tear line is formed in the central region of the outer tether.

4. The air bag module as set forth in claim 1, wherein the tear line is formed in the width direction of the outer tether.

5. The air bag module as set forth in claim 1, wherein the sewing portion is provided in a plural number.

6. The air bag module as set forth in claim 1, wherein a seam of the sewing portion is formed in the width direction of the outer tether.

7. The air bag module as set forth in claim 1, wherein a seam of the sewing portion is formed in the length direction of the outer tether.

8. The air bag module as set forth in claim 7, wherein the seam of the sewing portion is provided in a plural number in a width direction.

9. The air bag module as set forth in claim 1, wherein a seam of the sewing portion is formed at the left and right sides of the tear line.

10. The air bag module as set forth in claim 1, wherein
the sewing portion is sewn to be overlapped once.
